(19) United States
(12) Patent Application Publication
(10) Pub. No.: US 2005/0281502 A1
(43) Pub. Date: Dec. 22, 2005

(54) Three-dimensional optical waveguide and optical communication system

(75) Inventor: Masaki Kobayashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/209,854

(22) Filed: Aug. 24, 2005

(30) Foreign Application Priority Data
Mar. 9, 2004 (JP) 2005-65617

(51) Int. Cl. G02B 6/12

(52) U.S. Cl. 385/14

(57) ABSTRACT

A three-dimensional optical waveguide includes plural X-cores forming optical paths in a X-direction, plural Y-cores forming optical paths intersecting the X-cores at a specified angle in the X-Y plane, and a cladding having a different refractive index than that of the X-cores and the Y-cores and surrounding the X- and Y-cores. The X- and Y-cores are provided in each of one or more layers and intersecting each other in each layer to form a lattice.

### CROSS-REFERENCE TO RELATED APPLICATION

This application claims priority under USC 119 from Japanese Patent Application No. 2005-065617, the disclosure of which is incorporated by reference herein.

### BACKGROUND OF THE INVENTION

1. Field of the Invention

The present invention relates to a three-dimensional optical waveguide and an optical communication system and particularly, relates to a three-dimensional optical waveguide wherein plural optical paths can be formed and the direction of the optical paths can be converted into a different direction at two or more points and an optical communication system wherein the three-dimensional optical waveguide is employed.

2. Description of the Related Art

Recently, it has been studied to dispose the cores thereof in a three-dimensional lattice by layering plural two-dimensional optical waveguides to form an optical bus having a large communication capacity (Publication of unexamined patent application Nos. JP1999-183747 and JP2004-177730). Further, an optical path-vertically converting optical waveguide is proposed for connecting an optical device to optical fibers (JPCA Symposium ‘Advanced Packaging Technology for Optoelectronic Modules’). The optical path-vertically converting optical waveguide has a mirror for bending an optical path in a right angle at an end of an optical waveguide thereof.

However, the optical waveguides described in Publication of unexamined patent application Nos. JP1999-183747 and JP2004-177730 are optical waveguides wherein light is led in at one end and received at the other end. Any optical paths formed in the optical waveguides described in the above two references cannot be diverted to any desired directions.

Though an optical path disposed in the optical path-vertically converting optical waveguide shown in ‘Advanced Packaging Technology for Optoelectronic Modules’ can be diverted perpendicularly, for diverting the optical path to a different direction, another optical path converting guide is connected with the optical path-vertically converting optical waveguide by optical fibers or the like.

### SUMMARY OF THE INVENTION

The present invention has been made in view of the above circumstance and provides a three-dimensional optical waveguide and an optical communication system.

According to a first aspect of the present invention, a three-dimensional optical waveguide includes plural X-cores forming optical paths in the X-direction, plural Y-cores forming optical paths intersecting the X-cores at a specified angle in the X-Y plane, and a cladding having a different refractive index than those of the X- and the Y-cores and surrounding the X- and Y-cores. The X- and Y-cores are provided in each of one or more layers and intersecting each other in each layer to form a lattice.

### BRIEF DESCRIPTION OF THE DRAWINGS

Embodiments of the present invention will be described in detail based on the following figures, wherein:

FIG. 1 is a perspective view showing a constitution of a three-dimensional optical waveguide of a first embodiment;

FIGS. 2A, 2B, and 2C are sectional views showing sections of the three-dimensional optical waveguide shown in FIG. 1 sectioned along the X-Y plane, the Y-Z plane and the X-Z plane, respectively;

FIGS. 3A, 3B, and 3C are sectional views showing a different example of the three-dimensional optical waveguide;

FIGS. 4A to 4D are a schematic view showing a process for producing the three-dimensional optical waveguide of the first embodiment;

FIGS. 5A to 5D are a schematic view showing a process for producing an optical communication system of a second embodiment and the constitution thereof;

FIGS. 6A to 6C are a schematic view showing a process for producing a different example of the optical communication system of the second embodiment and the constitution thereof;

FIGS. 7A and 7B are a schematic view showing a process for producing a further different example of the optical communication system of the second embodiment and the constitution thereof;

FIGS. 8A and 8B are a schematic view showing a process for producing a further different example of the optical communication system of the second embodiment and the constitution thereof;

FIGS. 9A and 9B show a first and second steps of a process for producing an optical communication system of a third embodiment;

FIGS. 10A and 10B show the entire constitution of the optical communication system of the third embodiment;

FIGS. 11A to 11C show the constitution of an optical communication system of a fourth embodiment; and

FIGS. 12A and 12B show the constitution of an optical communication system of a fifth embodiment.

### DETAILED DESCRIPTION OF THE INVENTION

### 1. A First Embodiment

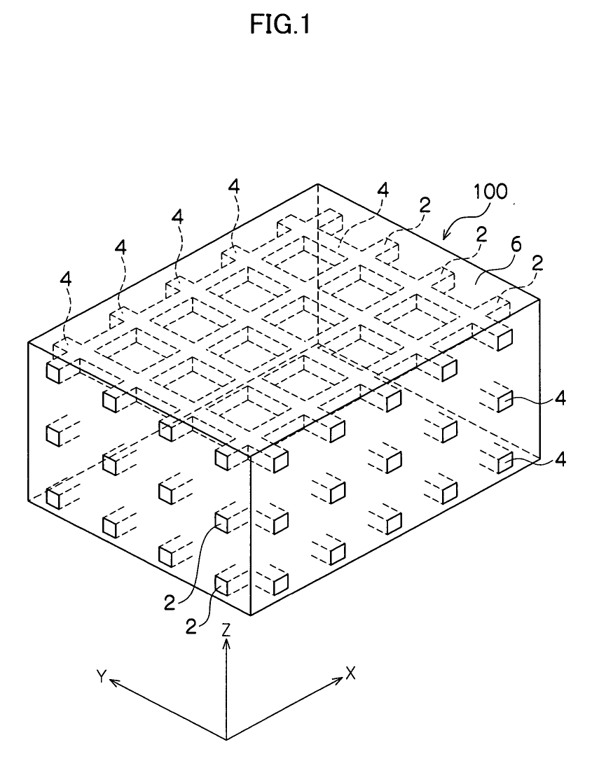

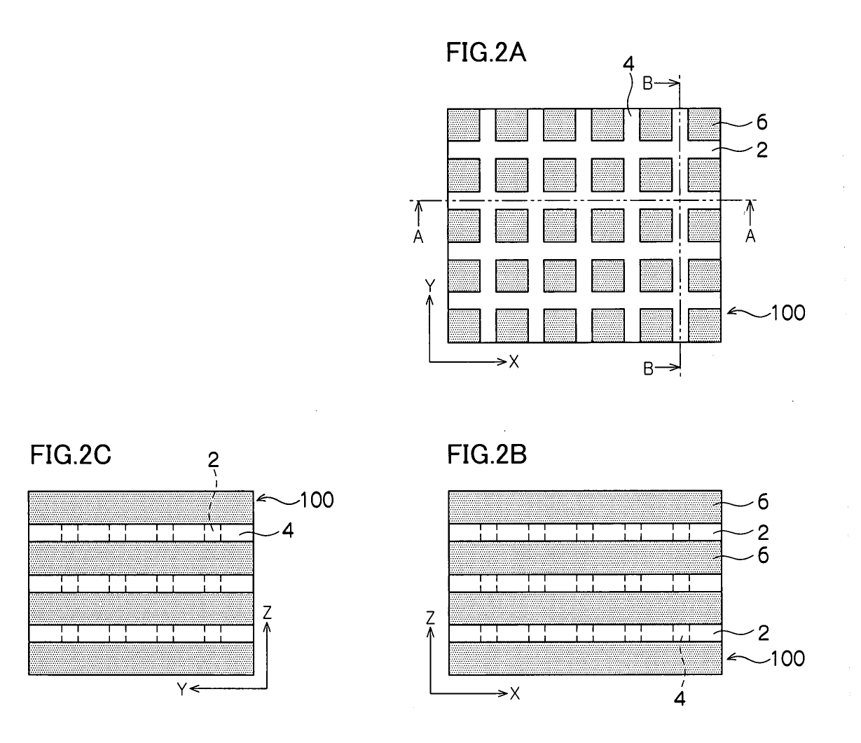

The constitution of a three-dimensional optical waveguide of a first embodiment is shown in FIG. 1, and FIGS. 2A to 2C. FIG. 2A is a sectional view of the three-dimensional optical waveguide of the first embodiment sectioned along the X-Y plane. FIGS. 2B and 2C show sectional views of the three-dimensional optical waveguide sectioned along the X-Z plane and the Y-Z plane, respectively.

As shown in FIG. 1 and FIGS. 2A to 2C, the three-dimensional optical waveguide 100 comprises X-cores 2 that are formed in the X-direction at regular intervals in plural layers, e.g., in three layers, and Y-cores 4 formed in the Y-direction at regular intervals in plural layers, e.g., in three layers.

The X-cores 2 and the Y-cores 4 have the same refractive index and intersect each other to form a lattice in each layer. The X-cores 2 and the Y-cores 4 are buried in a cladding 6 having a larger refractive index.

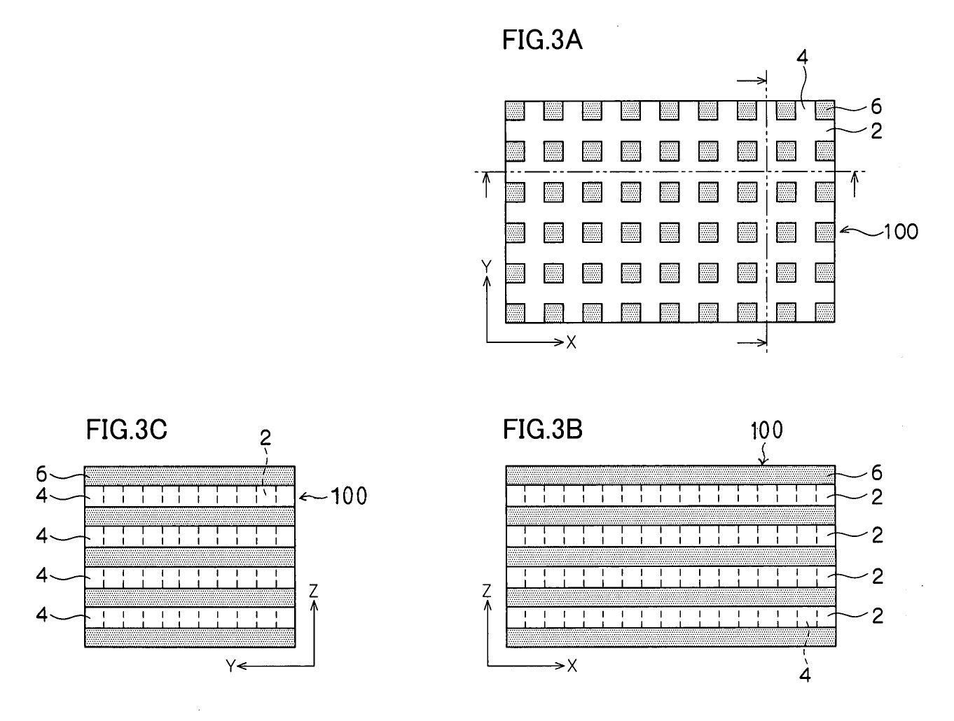

FIGS. 3A to 3C show an example of the three-dimensional optical waveguide 100 wherein the X-cores 2 and the Y-cores 4 have a larger height and width and are disposed at smaller intervals. FIG. 3A shows a sectional view of the example sectioned along the X-Y plane. FIGS. 3B and 3C show sectional views of the example sectioned along the X-Z planes and the Y-Z planes, respectively.

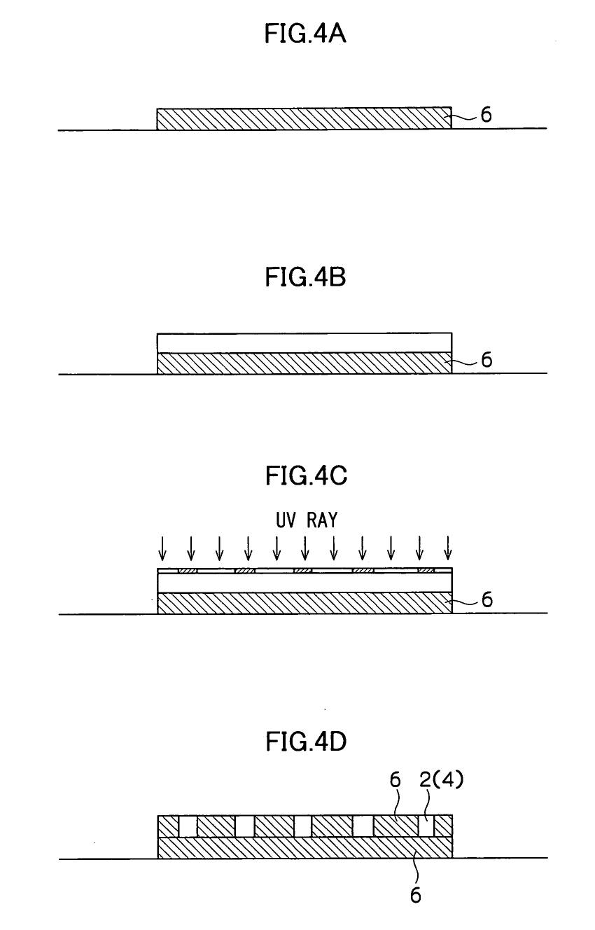

The three-dimensional optical waveguide 100 can be produced by a process shown by FIGS. 4A to 4D.

Firstly, as shown in FIG. 4A, a substrate is spin-coated with, for example but not limited to, polysilane and then, baked at a temperature of 250° C. to harden a polysilane layer on the substrate to form the cladding 6. Secondly, the cladding 6 is spin-coated with polysilane as shown in FIG. 4B and is irradiated with an ultraviolet light with the areas of the X-cores 2 and Y-cores 4 being masked as shown in FIG. 4C. After irradiating with the ultraviolet light for a predetermined time, the substrate is again baked at a temperature of 250° C. to harden the polysilane layer wherein the X-cores 2 and Y-cores 4 are patterned. By baking, the refractory index reduces only in the areas irradiated with the ultraviolet light and the areas turn into the cladding 6, while the areas not irradiated with the ultraviolet light turn into the X-cores 2 and the Y-cores 4.

The three-dimensional optical waveguide 100 is formed by repeating the procedure shown in FIGS. 4A to 4D.

### 2. A Second Embodiment

An example of an optical communication system, wherein the three-dimensional optical waveguide 100 of the first embodiment is employed, is described in the following.

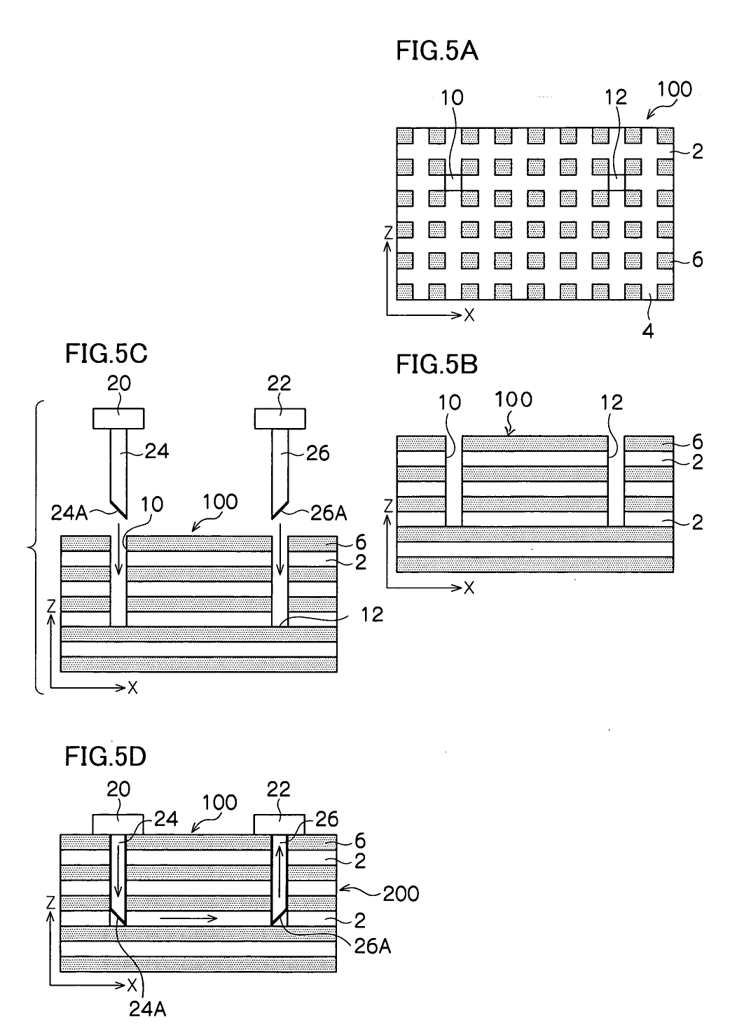

The optical communication system 200 is shown in FIGS. 5A to 5D. The optical communication system 200 is a combination of the three-dimensional optical waveguide 100 with a light-emitting device 20 and a light-receiving device 22. A VCSEL laser diode and a photo diode can be employed as the light-emitting device 20 and the light-receiving device 22, respectively.

A process for producing the optical communication system is described in the following.

Firstly, as shown in FIGS. 5A and 5B, an inserting hole 10 and an inserting hole 12 are formed at an intersection of a first X-core 2 and a first Y-core 4 and an intersection of the first X-core 2 and a second Y-core, respectively; the first X-core 2 and the first and the second cores 4 extend in the X-Y plane of the three-dimensional optical waveguide 100. Both the inserting holes 10 and 12 are formed by a technique such as dry-etching, or other methods known to those skilled in the art, in the Z-direction so as to reach an X-core 2 and a Y-core 4 in a predetermined layer, e.g., in a third layer.

Then, as shown in FIG. 5C, a Z-direction optical path 24 of the light-emitting device 20 is inserted into the inserting hole 10, and a Z-direction optical path 26 of the light-receiving device 22 is inserted into the inserting hole 12. The Z-direction optical path 24 and the Z-direction optical path 26 correspond to the light-emitting Z-direction optical path and the light-receiving Z-direction optical path of the present invention, respectively. The Z-direction optical paths 24 and 26 are transparent rod-like members having the same refractive index as those of the X-cores 2 and the Y-cores 4 of the three-dimensional optical waveguide 100. At each of the tips of the Z-direction optical paths 24 and the Z-direction optical path 26, a mirror surface 24A and a mirror surface 26A, each of which forms an angle of 45 degree with the side walls of the Z-direction optical paths 24 and 26, are formed, respectively. The mirror surfaces 24A and 26A can be formed by depositing a metal such as Al, Ag, or Au, or by forming a dielectric multi-layer film on the tips of the Z-direction optical path 24 and 26, respectively.

The constitution and the function of the optical communication system 200 thus formed are shown in FIG. 5D. In the optical communication system 200, as shown in FIG. 5D by an arrow, a laser beam emitted from the light-emitting device 20 is transmitted through the Z-direction optical path 24 and is reflected by the mirror surface 24A at the tip thereof to be led into an X-core 2 in the third layer.

The laser beam 2 is transmitted through the X-core 2 and led into the Z-direction optical path 26.

After being led into the Z-direction optical path 26, the laser beam is reflected perpendicularly by the mirror surface 26A deposited at the tip of the Z-direction optical path 26 and then, as shown by another arrow, guided upwardly in the Z-direction optical path 26 and received by the light-receiving device 22.

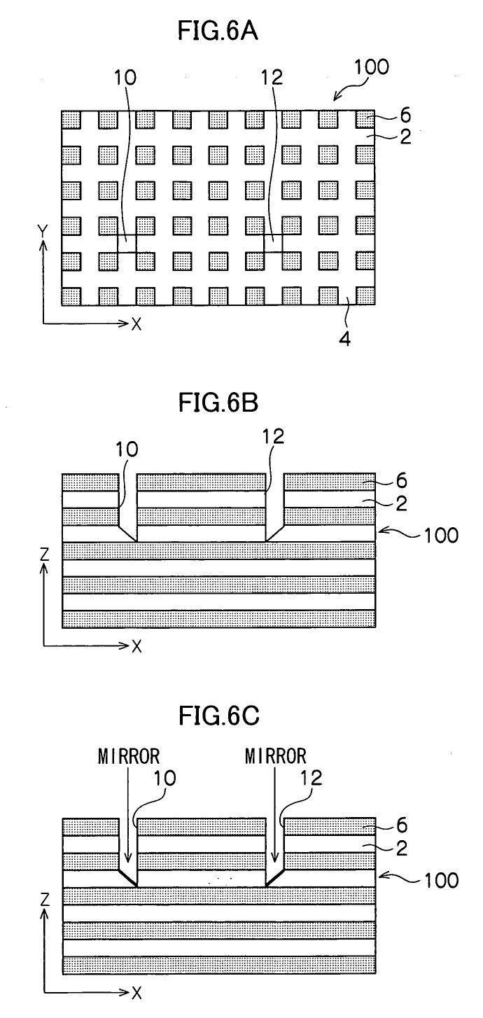

In the optical communication system 200, instead of forming the mirror surfaces 24A and 26A at each the tip of the Z-direction optical paths 24 and 26, as shown in FIGS. 5C and 5D, at the bottoms of the inserting holes 10 and 12, FIGS. 6B and 6C, inclined surfaces can be formed so as to face each other and slant at an angle of 45 degree to a perpendicular direction, then, a metal such as Al. Ag, or Au can be deposited or a dielectric multilayer film can be formed on the inclined surfaces to form mirror surfaces on the bottoms of the inserting holes 10 and 12.

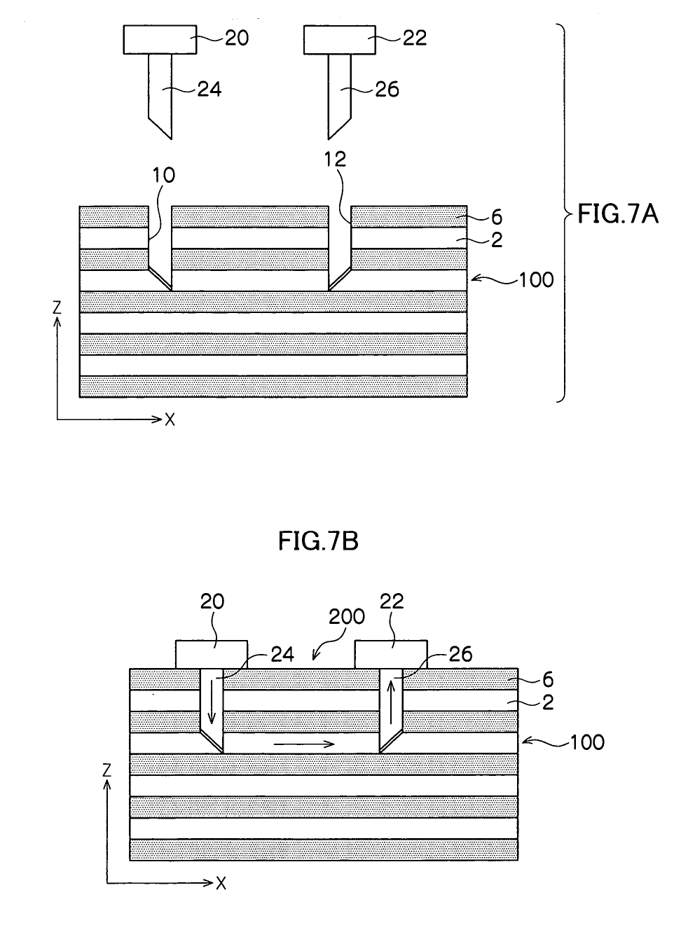

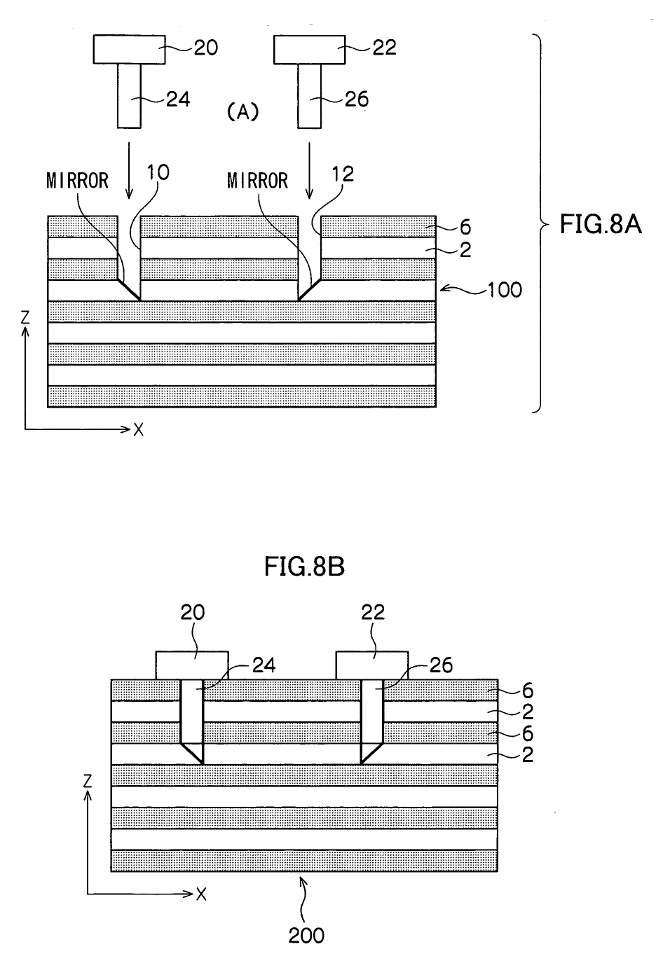

Then, as shown in FIGS. 7A and 7B, the end faces of the Z-direction optical paths 24 and 26, which are inserted into the inserting holes 10 and 12, respectively, can be shaped into inclined surfaces slanted in accordance with the inclination of the bottom surfaces of the inserting holes 10 and 12. Instead, as shown in FIGS. 8A and 8B, the Z-direction optical paths 24 and 26 can be inserted into the inserting holes 10 and 12 without shaping the end face thereof into inclined surfaces.

The optical communication system 200 can be constituted by forming the inserting holes 10 and 12 in the Z-direction at intersections of the X-cores 2 and the Y-cores 4 in the X-Y plane of the three-dimensional optical waveguide 100 and inserting the Z-direction optical path 24 of the light-emitting device 20 and the Z-direction optical path 26 of the light-receiving device 22 into the inserting holes 10 and 12, respectively.

Therefore, the light-emitting device 20 and the light-receiving device 22 can be connected to the three-dimensional optical waveguide 100 without using any specific couplers.

Additionally, two or more light-emitting device 20 and light-receiving device 22 can be easily connected by the three-dimensional optical waveguide 100 so that no cross-talk happens.

### 3. A Third Embodiment

A different example of an optical communication system, wherein the three-dimensional optical waveguide 100 of the first embodiment is employed, is described in the following.

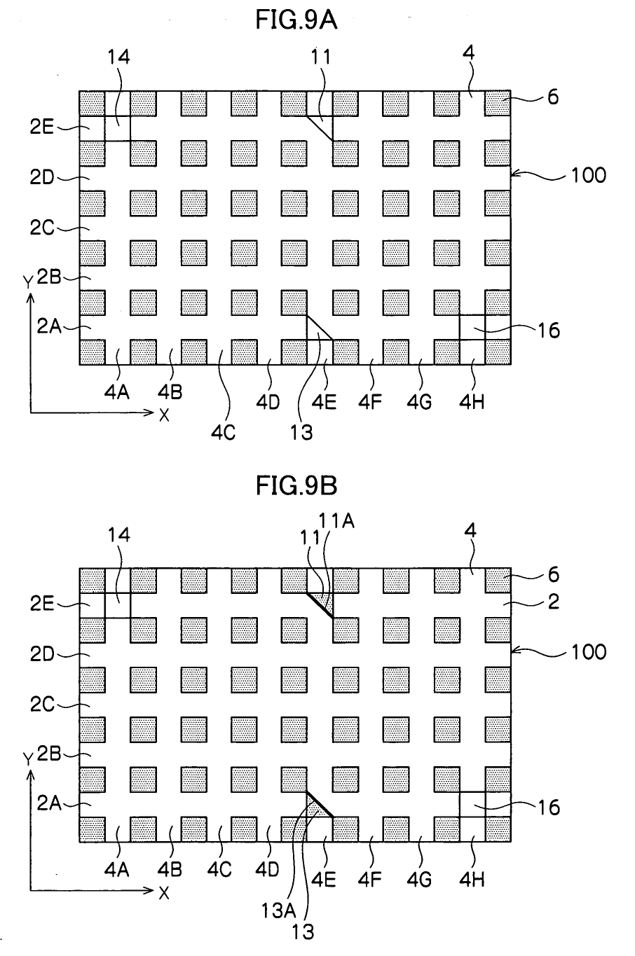

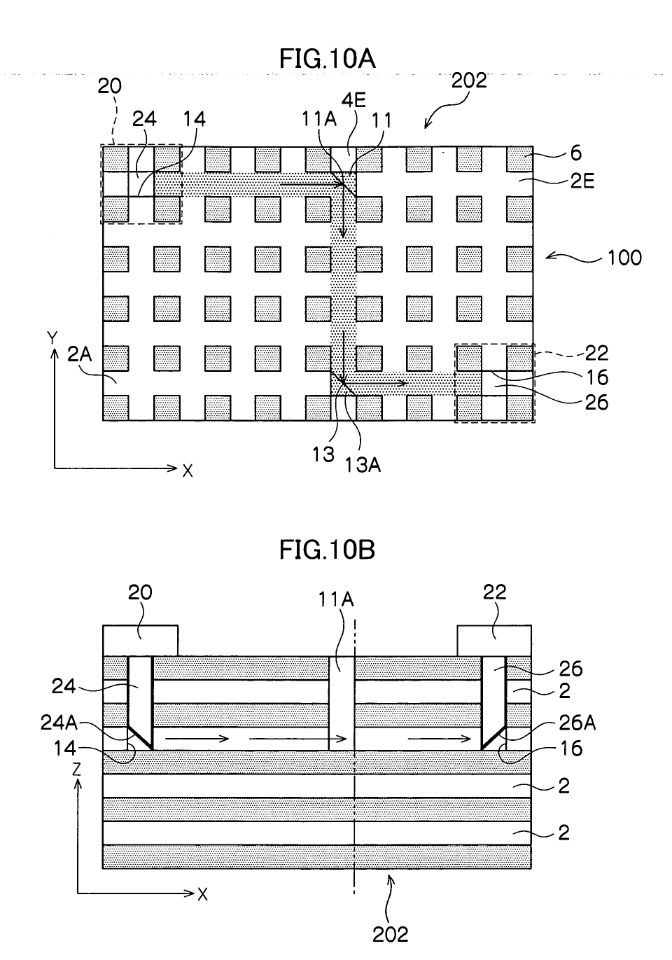

As shown in FIGS. 9A, 9B, 10A, and 10B, a three-dimensional optical waveguide 100 employed for constituting an optical communication system 202 comprises four layers of X-cores 2 and Y-cores 4. In each layer, five X-cores 2 or X-cores 2A to 2E, and eight Y-cores or Y-cores 4A to 4H are formed.

As shown in FIG. 9A, in the X-Y plane of the three-dimensional optical waveguide 100, inserting holes 14 and 16 are formed at the intersection of the X-core 2E with the Y-core 4A and the intersection of the X-core 2A with the Y-core 4H, respectively. Then, mirror holes 11 and 13 are formed at the intersection of the X-core 2E with the Y-core 4E and the intersection of the X-core 2E with the Y-core 4A, respectively.

All of the inserting holes 14 and 16 and the mirror holes 11 and 13 are formed so as to reach the X-cores 2 and the Y-cores 4 in the second layer from the top. As shown in FIGS. 9A and 9B, the mirror hole 11 is formed so that a mirror-forming surface thereof, which is an inclined surface, faces the inserting hole 14. The mirror hole 13 is formed so that a mirror-forming surface thereof, which is also an inclined surface, faces the inserting hole 16. Thus, the mirror holes 11 and 13 are formed so that their respective mirror-forming surfaces face each other.

Then, by depositing a metal such as Al, Ag, or Au, or forming a dielectric multilayer film on the mirror-forming surfaces of the mirror holes 11 and 13, mirror surfaces 11A and 13A are formed. The mirror surfaces 11A and 13A correspond to the optical path converting surface of the present invention.

Further, as shown in FIGS. 10A and 10B, the Z-direction optical path 24 of the light-emitting device 20 and the Z-direction optical path 26 of the light-receiving device 22 are inserted into the inserting holes 14 and 16, respectively to constitute the optical communication system 202. FIGS. 10A and 10B show a path in the X-Y plane and a path in the X-Z plane of the optical path formed in the optical communication system 202, respectively.

In the optical communication system 202, as shown by the arrow in FIGS. 10A and 10B, the laser beam emitted from the light emitting device 20 is transmitted through the X-core 2E and is led into the mirror surface 11A. Then, the laser beam is changed the direction thereof in an angle of 90 degrees and is led into the Y-core 4E wherein the laser beam is transmitted toward the mirror surface 13A. At the mirror surface 13A, the laser beam is changed the direction thereof in an angle of 90 degrees and led into the X-core 2A. Then, the laser beam is transmitted through the X-core 2A and led into the bottom of the Z-direction optical path 26. At the mirror surface 26A of the Z-direction optical path 26, the laser beam is changed the direction thereof upwardly and led into the light-receiving device 22.

As described in the above, even when the light-emitting device 20 and the light-receiving device 22 are not disposed on the same X-core 2 and the same Y-core 4, by forming mirror surface(s) in the three-dimensional optical waveguide 100, an optical path can be formed between the light-emitting device 20 and the light-receiving device 22.

### 4. A Fourth Embodiment

A further different example of an optical communication system, wherein the three-dimensional optical waveguide 100 of the first embodiment is employed, is described in the following.

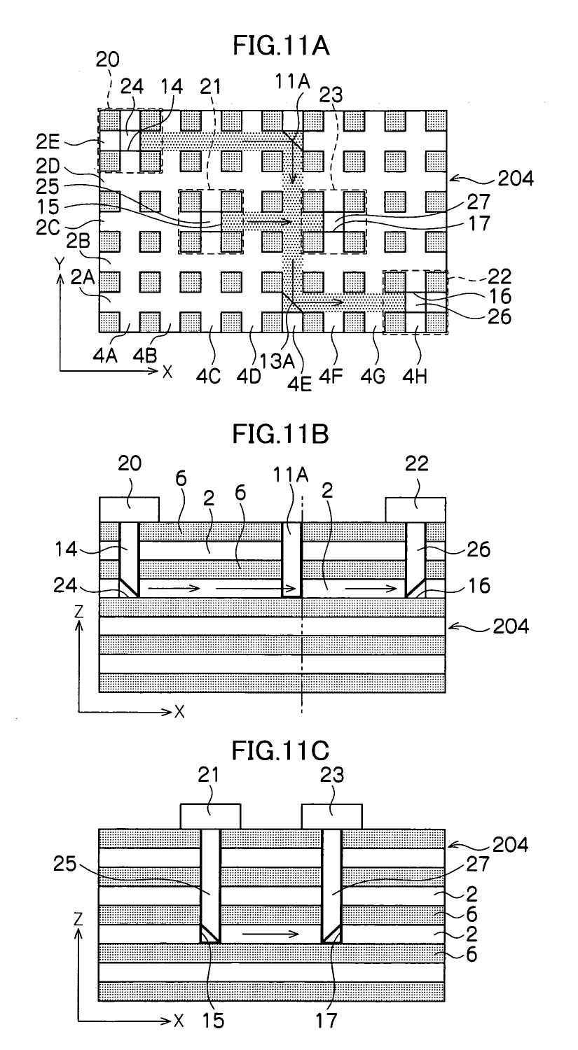

As shown in FIGS. 11A to 11C, an optical communication system 204 of a fourth embodiment is the optical communication system 202 of the third embodiment wherein a second optical path has been formed. In FIGS. 11A to 11C, the same reference numbers as those of FIGS. 9A, 9B, 10A, and 10B show the same elements shown in FIGS. 9A, 9B, 10A, or 10B

As shown in FIGS. 11A to 11C, in the optical communication system 204, in addition to the inserting holes 14 and 16, inserting holes 15 and 17 are formed at the intersection of the X-core 2C and the Y-core 4C and at the intersection of the X-core 2C and the Y-core 4F, respectively. The inserting holes 15 and 17 are formed to reach the X-cores 2 in the fourth layer from the top, which is one layer deeper than the third layer that the inserting holes 14 and 16 reach.

Then, as shown in FIG. 11B, in the inserting holes 14 and 16, the light-emitting device 20 and the light-receiving device 22 are disposed through the Z-direction optical paths 24 and 26, respectively. On the other hand, in the inserting holes 15 and 17, the light-emitting device 21 and the light-receiving device 23 are disposed through the Z-direction optical paths 25 and 27, respectively. Each of the Z-direction optical paths 24, 25, 26, and 27 is processed so that a bottom surface thereof slants at an angle of 45 degrees from the perpendicular direction. Then, a metal such as Al, Ag, or Au is deposited over the bottom surface thereof to form a mirror surface. The light-emitting device 20 and the light-receiving device 22 are set in the inserting holes 14 and 16 so that the mirror surfaces thereof face each other. The light-emitting device 21 and the light-receiving device 23 are set in the inserting holes 15 and 17 so that the mirror surfaces thereof face each other.

In the optical communication system 204, between the light-emitting device 20 and the light-receiving device 22, an optical path that is the same as described in the description of the optical communication system of the third embodiment is formed. On the other hand, as shown in FIG. 11C, between the light-emitting device 21 and the light-receiving device 23, an optical path through the Z-direction optical path 27, the X-core 2C in the fourth layer from the top, and the Z-direction optical path 27 is formed.

Thus, by using the three-dimensional optical waveguide 100, plural optical paths can be easily formed.

### 5. A Fifth Embodiment

A further different example of an optical communication system, wherein the three-dimensional optical waveguide 100 of the first embodiment is employed, is described in the following.

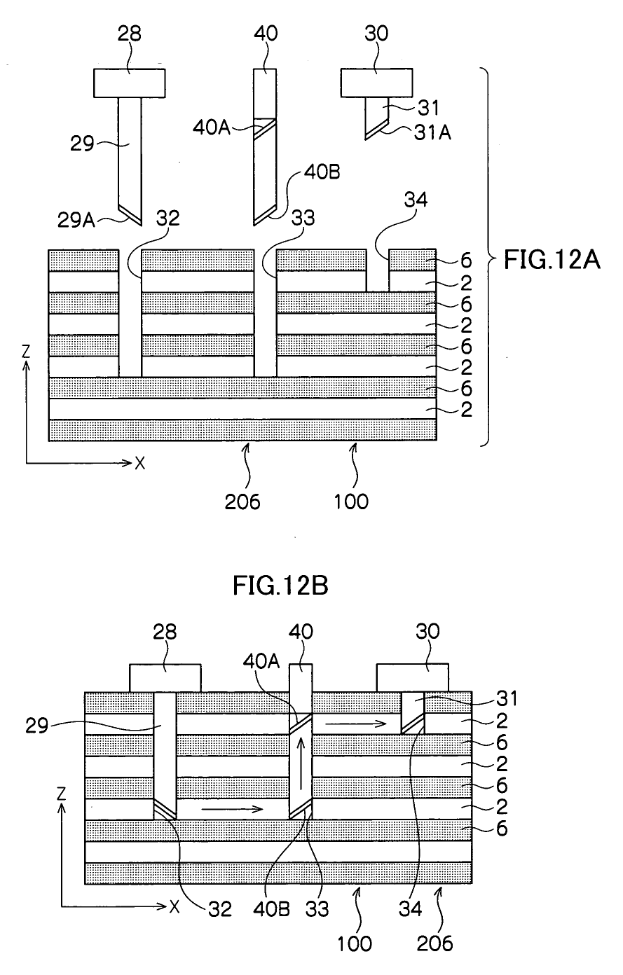

As shown in FIG. 12A, in an optical communication system of a fifth embodiment, at the intersection of a first X-core 2 and a first Y-core 4 of the three-dimensional optical waveguide 100, at the intersection of the first X-core 2 and a second Y-core 4, and at the intersection of the first X-core 2 and a third Y-core 4, inserting holes 32, 33, and 34 are formed in the Z-direction, respectively. The inserting holes 32 and 33 are formed to a depth so as to reach an X-core 2 in the third layer from the top. The inserting hole 34 is formed to a depth so as to reach an X-core 2 in the first layer from the top.

As shown in FIG. 12B, a Z-direction optical path 29 of a light-emitting device 28 and a Z-direction optical path 31 of a light-receiving device 30 are inserted into the inserting holes 32 and 34, respectively. In addition, in the inserting hole 33, a Z-direction optical path 40 connecting X-cores 2 in the first and the fourth layers together is inserted.

The Z-direction optical paths 29 and 31 are transparent rod-like members having a refractive index that is the same as those of the X-cores and the Y-cores 4 and have a length sufficient to reach the bottom of the inserting holes 33 and 34, respectively. Mirror surfaces 29A and 31A are formed on the tip of the Z-direction optical paths 29 and 31, respectively.

The Z-direction optical path 40 is also a transparent rod-like member having a refractive index that is the same as those of the X-cores 2 and the Y-cores 4 and mirror surfaces 40A and 40B are formed at the top and at the bottom, respectively. The mirror surfaces 40A and 40B are formed so that the mirror surfaces 40A and 40B are at the same position as the X-cores 2 in the first and the fourth layers, respectively when the Z-direction optical path 40 is inserted into the inserting hole 33.

In the optical communication system 206, as shown by an arrow in FIG. 12B, by the Z-direction optical path 29, an optical path extending in the Z-direction and connecting the light-emitting device 28 to the X-core 2 in the fourth layer is formed, and by the Z-direction optical path 40, an optical path extending in the Z-direction and connecting the X-core 2 in the fourth layer to the X-core 2 in the first layer is formed. Additionally, by the Z-direction optical path 31, an optical path extending in the Z-direction and connecting the X-core 2 in the first layer to the light-receiving device 30 is formed by the Z-direction optical path 31.

As described so far, according to a first aspect of the present invention, a three-dimensional optical waveguide includes plural X-cores forming optical paths in the X-direction, plural Y-cores forming optical paths intersecting the X-cores at a specified angle in the X-Y plane, and a cladding having a different refractive index than those of the X- and the Y-cores and surrounding the X- and Y-cores. The X- and Y-cores are provided in each of one or more layers and intersecting each other in each layer to form a lattice.

In the three-dimensional optical waveguide of the first aspect, the X-cores have a different refractive index from that of the cladding, and thus, light lead into the X-cores from a light-emitting device is entirely reflected on the boundary of the X-cores and the cladding and transmitted in the X-cores. It is the same for light that is led into the Y-cores from the light-emitting device.

Therefore, optical paths in the X-direction are formed by the X-cores and optical paths in the Y-direction are formed by the Y-cores. Additionally, optical paths different from the optical paths in one layer can be formed in other layer. Additionally, by forming a Z-direction optical path mentioned in the following, an optical path that is diverted in two-dimension can be freely formed in one layer.

The Y-cores may intersect X-cores perpendicularly in the X-Y plane.

The three-dimensional optical waveguide may further include an optical path converting device disposed at an intersection of the X- and Y-cores and converting an optical path between an X-core and a Y-core crossing at the intersection.

The optical path converting device may be inserted in a hole formed in the three-dimensional optical waveguide.

The optical path converting device may be a mirror disposed at an intersection of the lattice.

Alternatively, the optical path converting device may be a specular surface formed in the three-dimensional optical waveguide, or a metallic surface formed by depositing a metal on the specular surface.

In the above three-dimensional optical waveguide, light transmitted in the X- or Y-cores can be turned to the Y- or X-cores by the optical path converting device. Thus, an optical path bending in two dimension can be formed in the three-dimensional optical waveguide.

In the above three-dimensional optical waveguide, the X- and Y-cores may be provided in each of two or more layers, and one and another one of the two or more layers may be connected in a Z-direction which is perpendicular to both X- and Y-directions, and the three-dimensional optical waveguide further includes a Z-direction optical path extending in the Z-direction and having an optical path converting device at least at one end thereof for converting the direction of an optical path between the Z-direction optical path and at least one of the X- and Y-cores.

The optical path converting device provided at the at least one end of the Z-direction optical path may be a mirror diverting an optical path between the Z-direction optical path and at least one of the X-cores and the Y-cores.

In the above three-dimensional optical waveguide, an X-core in a first layer and an X-core or a Y-core in a second layer can be connected with each other by the Z-direction optical path to form one optical path extending from the first layer to the second layer with bending in three dimension.

In the above optical path, light led into the X-core of the first layer is led into the Z-direction optical path at an intersection of the X-core and the Z-direction optical path by the optical path converting device disposed at one end of the Z-direction optical path. Then, the light is led into the X-core or the Y-core of the second layer.

According to another aspect of the present invention, an optical communication system includes a light-emitting device, a light-receiving device, and one of the above three-dimensional optical waveguides transmitting the light emitted by the light-emitting device to the light-receiving device.

In the optical communication system of the above aspect, an optical path extending in the X- and/or Y-directions can be formed. Accordingly, the light-emitting device and the light-receiving device can be positioned more flexibly than when employing a conventional three-dimensional optical waveguide.

The above optical communication system may further includes a first Z-direction optical path being disposed in the three-dimensional optical waveguide and transmitting the light emitted by the light-emitting device to a specific layer of the three-dimensional optical waveguide in the Z-direction, which is perpendicular to both X- and Y-directions, and a second Z-direction optical path being disposed in the three-dimensional optical waveguide and leading the light transmitted in the specific layer to the light-receiving device.

The light-emitting device and the first Z-direction optical path may be integrated into a light-emitting module, the light-receiving device and the second Z-direction optical path may be integrated into a light-receiving module, and both the light-emitting module and the light-receiving module may be inserted into a hole formed at a specific point of the three-dimensional optical waveguide.

In the above optical communication system, the light-emitting device and the light-receiving device are connected to the three-dimensional optical waveguide by a Z-direction optical path. Thus, an optical path connecting the light-receiving device with the light-receiving path can be formed without using an optical fiber connector that is often expensive and complicated. Additionally, optical alignment between the light-emitting device, the light-receiving device, and the three-dimensional optical waveguide can be extremely easily practiced.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A three-dimensional optical waveguide comprising:
a plurality of X-cores forming optical paths in a X-direction;
a plurality of Y-cores forming optical paths intersecting the X-cores at a specified angle in the X-Y plane; and
a cladding having a refractive index different from that of the X-cores and the Y-cores and surrounding the X- and Y-cores,
the X- and Y-cores being provided in each of one or more layers and intersecting each other in each layer to form a lattice.

2. The three-dimensional optical waveguide of claim 1, wherein the Y-cores intersect the X-cores perpendicularly in the X-Y plane.

3. The three-dimensional optical waveguide of claim 1, further comprising an optical path converting device disposed at an intersection of the X- and Y-cores and converting an optical path between an X-core and a Y-core intersecting at the intersection.

4. The three-dimensional optical waveguide of claim 3, wherein the optical path converting device is inserted into a hole formed in the three-dimensional optical waveguide.

5. The three-dimensional optical waveguide of claim 3, wherein the optical path converting device is a mirror disposed at an intersection of the lattice.

6. The three-dimensional optical waveguide of claim 3, wherein the optical path converting device is a specular surface formed in the three-dimensional optical waveguide, or a metallic surface formed by depositing a metal on the specular surface.

7. The three-dimensional optical waveguide of claim 1, wherein the X- and Y-cores are provided in each of two or more layers, and one and another of the two or more layers are connected in a Z-direction which is perpendicular to both X- and Y-directions, and wherein the three-dimensional optical waveguide further comprises a Z-direction optical path extending in the Z-direction and having an optical path converting device at least at one end thereof for converting the direction of an optical path between the Z-direction optical path and at least one of the X- and Y-cores.

8. The three-dimensional optical waveguide of claim 7, wherein the optical path converting device provided at the at least one end of the Z-direction optical path is a mirror bending an optical path between the Z-direction optical path and at least one of the X-cores and the Y-cores.

9. An optical communication system comprising:
a light-emitting device;
a light-receiving device; and
a three-dimensional optical waveguide transmitting the light emitted by the light-emitting device to the light-receiving device, the three-dimensional optical waveguide comprising:
a plurality of X-cores forming optical paths in a X-direction;
a plurality of Y-cores forming optical paths intersecting the X-cores at a specified angle in the X-Y plane; and
a cladding having a refractive index different from that of the X-cores and the Y-cores and surrounding the X- and Y-cores,
the X- and Y-cores being provided in one or more layers and intersecting each other in each layer to form a lattice

10. The optical communication system of claim 9, further comprising:
a first Z-direction optical path being disposed in the three-dimensional optical waveguide and transmitting the light emitted by the light-emitting device to a specific layer of the three-dimensional optical waveguide in a Z-direction thereof, the Z-direction being perpendicular to both X- and Y-directions; and
a second Z-direction optical path being disposed in the three-dimensional optical waveguide and leading the light transmitted through the specific layer to the light-receiving device.

11. The optical communication system of claim 10, wherein the light-emitting device and the first Z-direction optical path are integrated into a light-emitting module and the light-receiving device and the second Z-direction optical path are integrated into a light-receiving module,
the light-emitting module and the light-receiving module being inserted into a hole formed at a specific point of the three-dimensional optical waveguide.
